(19) United States
(12) Patent Application Publication
(10) Pub. No.: US 2025/0193359 A1
(43) Pub. Date: Jun. 12, 2025

(54) METHOD, APPARATUS, ELECTRONIC DEVICE, AND STORAGE MEDIUM FOR IMAGE DISPLAY

(71) Applicant: Beijing Zitiao Network Technology Co., Ltd., Beijing (CN)

(72) Inventor: Xiaosong Wang, Beijing (CN)

(21) Appl. No.: 18/977,148

(22) Filed: Dec. 11, 2024

(30) Foreign Application Priority Data
Dec. 12, 2023 (CN) 202311704099.9

(51) Int. Cl. H04N 13/139; H04N 13/383

(52) U.S. Cl. CPC H04N 13/139; H04N 13/383

(57) ABSTRACT

The disclosure relates to a method, an apparatus, an electronic device, and a storage medium for image display. The method includes: obtaining a first image; determining a target area and a non-target area; obtaining a first sub-image and a second sub-image based on the first image, where the first sub-image and the second sub-image are stored in different buffers, the first sub-image corresponds to both the target area and the non-target area, and the second sub-image corresponds to the target area; and displaying the first sub-image and the second sub-image on a screen of a terminal device, to cause image definition in the non-target area to be lower than image definition in the target area.

### CROSS REFERENCE

The application claims priority to Chinese Patent Application No. 202311704099.9, filed on Dec. 12, 2023 and entitled “METHOD, APPARATUS, ELECTRONIC DEVICE, AND STORAGE MEDIUM FOR IMAGE DISPLAY”, the entirety of which is incorporated herein by reference.

### FIELD

The disclosure relates to the field of image processing technologies, and in particular, to a method, an apparatus, an electronic device and a storage medium for image display.

### BACKGROUND

An extended reality (Extended Reality, XR for short) refers to a virtual environment that can be interacted between human and computer by combining reality and virtual through a computer. This is also a general term for various technologies such as AR, VR, and MR. The extended reality brings an “immersive” experience to experiencers that the virtual world and the real world are seamlessly switched.

In the prior art, a method for an extended reality device to display an image includes: combining image layers to be displayed to obtain a frame image to be displayed, storing the frame image to be displayed in a buffer (that is, a single buffer), extracting the frame image to be displayed from the buffer when it is time to display the frame image to be displayed, and sending a processing result obtained after the frame image to be displayed is processed by an HWC (HwComposer, hardware composer) to a rear-end module behind the HWC for on-screen display. With this method, definition of each position of an image finally displayed on a screen of an extended reality device is the same, which may cause waste of resources such as a memory bandwidth to a certain extent. Moreover, the existing method has high requirements for resources such as hardware of the terminal device, resulting in high manufacturing costs of the extended reality device.

### SUMMARY

In order to solve the above technical problems or at least partially solve the above technical problems, The disclosure provides a method, an apparatus, an electronic device, and a storage medium for image display.

In a first aspect, the disclosure provides a method of image display, comprising: obtaining a first image;
determining a target area and a non-target area, wherein the target area is an estimated result of an area with eye gaze when the first image is displayed on a screen of a terminal device, and the non-target area is an estimated result of an area without eye gaze when the first image is displayed on the screen of the terminal device; obtaining a first sub-image and a second sub-image based on the first image, wherein the first sub-image and the second sub-image are stored in different buffers, the first sub-image corresponds to both the target area and the non-target area, and the second sub-image corresponds to the target area; and displaying the first sub-image and the second sub-image on the screen of the terminal device, to cause image definition in the non-target area to be lower than image definition in the target area.

In a second aspect, the disclosure further provides an apparatus for image display, comprising: an obtaining module configured to obtain a first image; a determining module configured to determine a target area and a non-target area, wherein the target area is an estimated result of an area with eye gaze when the first image is displayed on a screen of a terminal device, and the non-target area is an estimated result of an area without eye gaze when the first image is displayed on the screen of the terminal device; a decomposition module configured to obtain a first sub-image and a second sub-image based on the first image, wherein the first sub-image and the second sub-image are stored in different buffers, the first sub-image corresponds to both the target area and the non-target area, and the second sub-image corresponds to the target area; and a display module configured to display the first sub-image and the second sub-image on the screen of the terminal device, to cause image definition in the non-target area to be lower than image definition in the target area in the first image.

In a third aspect, the disclosure further provides an electronic device, comprising: one or more processors; a storage device configured to store one or more programs, wherein the one or more programs, when executed by the one or more processors, cause the one or more processors to perform the method of image display as described above.

In a fourth aspect, the disclosure further provides a computer-readable storage medium having a computer program stored thereon, wherein the program, when executed by a processor, performs the method of image display as described above.

Compared with the prior art, the technical solutions provided in embodiments of the disclosure have the following advantages:

In the technical solutions provided in embodiments of the disclosure, through setting, the target area and the non-target area are determined; the target area is an estimated result of an area with eye gaze when the first image is displayed on the screen of the terminal device, and the non-target area is an estimated result of an area without eye gaze when the first image is displayed on the screen of the terminal device; the first sub-image and the second sub-image are obtained based on the first image; the first sub-image and the second sub-image are stored in different buffers; the first sub-image corresponds to both the target area and the non-target area, and the second sub-image corresponds to the target area; the first sub-image and the second sub-image are displayed on the screen of the terminal device, to cause image definition in the non-target area of the first image to be lower than image definition in the target area, which is essentially to reduce image definition outside a focus range in the first image, so as to achieve the purposes of reducing an amount of memory resources required for storing the first image and a bandwidth required for reading and writing the first image, thereby achieve the purposes of improving memory usage efficiency, saving storage space, accelerating image processing speed, reducing network transmission costs, adapting to different hardware configurations, and reducing manufacturing costs of terminal devices.

### BRIEF DESCRIPTION OF DRAWINGS

The accompanying drawings, which are incorporated in and constitute a part of this specification, illustrate embodiments consistent with the disclosure and, together with the description, serve to explain the principles of the disclosure.

In order to more clearly describe the technical solutions in embodiments of the disclosure or in the prior art, the following briefly introduces the accompanying drawings required for describing the embodiments or the prior art. Apparently, those of ordinary skill in the art can still derive other drawings from these accompanying drawings without creative efforts.

FIG. 1 is a schematic diagram of image display in a terminal device;

FIG. 2 is a flowchart of a method of image display according to an embodiment of the disclosure;

FIG. 3 is a flowchart of another method of image display according to an embodiment of the disclosure;

FIG. 4 is a schematic diagram of an image display principle according to an embodiment of the disclosure;

FIG. 5 is a schematic diagram of a structure of an apparatus for image display according to an embodiment of the disclosure; and

FIG. 6 is a schematic diagram of a structure of an electronic device according to an embodiment of the disclosure.

### DETAILED DESCRIPTION

In order to more clearly understand the above objectives, features, and advantages of the disclosure, the solutions of the disclosure are further described below. It should be noted that, without conflict, embodiments of the disclosure and features in the embodiments may be combined with each other.

A large number of specific details are set forth in the following description to fully understand the disclosure, but the disclosure may also be implemented in other manners different from those described herein. Obviously, the embodiments in the description are only some embodiments of the disclosure, rather than all embodiments.

For ease of understanding, an overall process of image display is first briefly described.

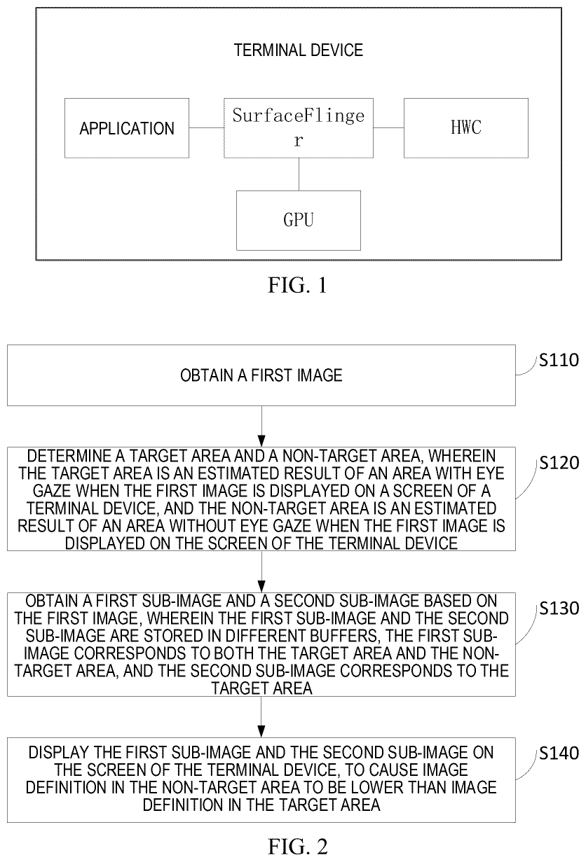

FIG. 1 is a schematic diagram of image display in a terminal device. Referring to FIG. 1, a hardware related to image display in the terminal device includes, but is not limited to, a graphics processing unit (GPU for short) and a hardware composer (HwComposer, HWC). The HWC may be an independent device, or may be integrated into a system-on-chip (SOC). The terminal device completes image display through interaction between an application, the GPU, and the HWC.

Image display is a process of processing data related to a frame image to be displayed based on a display pipeline and then displaying the data on a screen of the terminal device. The display pipeline mainly includes a drawing and rendering process, an image layer synthesizing process, and a display process. In other words, for a specific frame image, a display system needs to sequentially perform the drawing and rendering process, the image layer synthesizing process, and the display process, and then display the frame image on the screen of the terminal device. The drawing and rendering process mainly involves a process from an application stage to a geometry stage and then to a rasterization stage. In the application stage, a CPU prepares scene data (such as camera position, a viewing frustum, a model, a light source, and the like), and performs coarse-grained culling, to cull objects that cannot be seen by cameras, so that rendering efficiency can be effectively improved. Then, the data enters the geometry stage. This stage is mainly performed by a GPU, to perform point-by-point and polygon-by-polygon operations on rendering primitives based on data provided in the application stage, and convert vertex coordinates into a screen space. In the rasterization stage, the GPU performs rasterization on vertex data transmitted in the previous stage to generate pixels displayed on the final screen, to complete the final rendering. The image layer synthesizing process is mainly to stack and combine a plurality of image layers to finally form a complete image, and store the complete image in a buffer. The image layer synthesizing process is completed on the GPU. The display process is mainly a process of extracting an image from the buffer, processing the extracted image by the HWC (HwComposer, hardware composer), and sending a processing result to a rear-end module behind the HWC for on-screen display.

FIG. 2 is a flowchart of a method of image display according to an embodiment of the disclosure. The embodiment is applicable to a case where a terminal device performs image display. The method may be performed by an apparatus for image display. The apparatus may be implemented in a manner of software and/or hardware, and may be configured in a terminal device, including, but not limited to, a smart phone, a palmtop computer, a tablet computer, a wearable device with a display screen, a desktop computer, a notebook computer, an all-in-one machine, a smart home device, and the like. The wearable device with a display screen includes, but is not limited to, an extended reality terminal device. The extended reality terminal device is a terminal that can implement an extended reality effect, and can usually be provided in the form of glasses, a head mount display (Head Mount Display, HMD), or contact lenses, to implement visual perception and other forms of perception. Certainly, the form implemented by the extended reality terminal device is not limited thereto, and the form can be further miniaturized or enlarged as required. Further, the method may be performed by the GPU and the HWC in the apparatus for image display in cooperation. The method of image display provided in the disclosure optimizes the display process mentioned above.

As shown in FIG. 2, the method specifically may include the following steps.

At S110, obtain a first image.

An image layer is a basic unit of interface rendering. Specifically, in the drawing and rendering process, each interface corresponds to one surface object. The surface object is similar to a transparent canvas, and the interface draws its content on the canvas corresponding to the interface. Subsequently, the already drawn surface objects need to be synthesized. It is similar to stacking a plurality of films together to combine a final interface effect. These surface objects are stacked together in a specific order, and content drawn on an upper interface covers content drawn on a lower interface. Each interface is an independent image layer (Layer), and each image layer can be independently drawn and edited. Attributes such as stacking sequence and transparency between the image layers can be freely adjusted to achieve the final interface effect.

The first image refers to an image obtained after the drawing and rendering process and the image layer synthesizing process. In other words, the first image is a result of synthesizing the plurality of image layers.

In an example, assuming that a user uses an extended reality device to watch a video, in this scenario, the plurality of image layers that constitute the first image include at least one of: a virtual background image layer that reflects a room in which the user is located, a video image layer, or a bullet chat image layer.

There is a plurality of implementation methods for this step, and this application is not limited thereto. In an example, the implementation method of the step may include: obtaining a plurality of image layers that constitute the first image; and synthesizing the plurality of image layers to obtain the first image.

At S120, determining a target area and a non-target area, wherein the target area is an estimated result of an area with eye gaze when the first image is displayed on a screen of a terminal device, and the non-target area is an estimated result of an area without eye gaze when the first image is displayed on the screen of the terminal device.

For example, the target area may be an estimated area with eye gaze of the user after the first image is displayed on the screen of the terminal device. The target area is an estimated result. This is because the first image is not currently displayed on the screen of the terminal device, but an image before the first image is displayed. A timestamp corresponding to the image currently displayed on the screen of the terminal device is earlier than a timestamp corresponding to the first image. In an example, an image currently displayed on the screen of the terminal device is a pth frame image, and the first image is a (p+q)th frame image. Both p and q are positive integers greater than or equal to 1. Because the first image is not currently displayed on the screen of the terminal device, the target area is an area most likely with eye gaze of the user when the first image is displayed on the screen of the terminal device, which is inferred based on a current display situation and/or a user focus situation. The non-target area is a remaining area other than the target area.

There is a plurality of implementation methods for this step, and this application is not limited thereto. In an example, position information of a current user focus is determined by using a focus tracking technology; the target area is obtained based on the position information of the current user focus; and the area other than the target area is determined as the non-target area.

The focus tracking technology may specifically be to capture and calculate motion data of a head and/or eyes of a user by using a built-in sensor of the terminal device, such as a head tracking sensor or an eye tracking sensor; and convert the motion data captured by the head tracking sensor and/or the eye tracking sensor into position information of a focus. The “converting the motion data captured by the head tracking sensor and/or the eye tracking sensor into the position information of the focus” may specifically include: converting the motion data captured by the head tracking sensor and/or the eye tracking sensor into the position information of the focus by using a pupil-corneal reflection (Pupil-CR) eye tracking algorithm. Alternatively, the motion data captured by the head tracking sensor and/or the eye tracking sensor is input into a deep learning model that can predict the focus, to obtain the position information of the focus.

At S130, obtain a first sub-image and a second sub-image based on the first image, wherein the first sub-image and the second sub-image are stored in different buffers, the first sub-image corresponds to both the target area and the non-target area, and the second sub-image corresponds to the target area.

The essence of this step is to project the target area and the non-target area on the first image; and process the first image into two images, that is, the first sub-image and the second sub-image, based on a position of a projection area corresponding to the target area in the first image and a position of a projection area corresponding to the non-target area in the first image, and store the first sub-image and the second sub-image in different buffer.

Projecting the target area on the first image may, for example, mean determining an area with eye gaze in the first image on an assumption that the first image is displayed on the screen of the terminal device. The area with eye gaze in the first image is a projection area of the target area in the first image. Projecting the non-target area on the first image is similar to projecting the target area on the first image, and details of this are not described herein again.

A person skilled in the art may understand that if the first image is displayed on the screen of the terminal device, a part of a picture of the first image will fall into an area with eye gaze, and another part of the picture will fall into an area without eye gaze. In some embodiments, a picture falling into the area with eye gaze is used as the second sub-image, and the first image as a whole is used as the first sub-image.

At S140, displaying the first sub-image and the second sub-image on the screen of the terminal device, to cause image definition in the non-target area to be lower than image definition in the target area.

Image definition may for example be a clarity degree of details, textures, and boundaries on an image, and is affected by resolution of pixels and details on the image.

In this step, “image definition in the non-target area to be lower than image definition in the target area” may for example be implemented by the following method: reducing image definition of the first sub-image, and keeping image definition of the second sub-image unchanged.

A same image occupies different memories and bandwidths at different definitions. Specifically, for the same image, lower image definition means poorer image quality, and smaller amount of memory resources required for storing the image and smaller bandwidth required for reading and writing the image. In practice, the first image is usually a high-definition image. Reducing image definition of the first image can reduce an amount of memory resources required for storing the first image and a bandwidth required for reading and writing the first image.

When a user watches an image displayed on a screen of a terminal device, if the user perceives that the size of the screen of the terminal device is large, usually only a local area of the image displayed on the terminal device is within a focus range of human eyes, and the human eyes are not sensitive to image definition outside the focus range. The above technical solution, through setting, determines the target area and the non-target area; the target area is an estimated result of an area with eye gaze when the first image is displayed on the screen of the terminal device, and the non-target area is an estimated result of an area without eye gaze when the first image is displayed on the screen of the terminal device; the first sub-image and the second sub-image are obtained based on the first image; the first sub-image and the second sub-image are stored in different buffers; the first sub-image corresponds to both the target area and the non-target area, and the second sub-image corresponds to the target area; the first sub-image and the second sub-image are displayed on the screen of the terminal device, to cause image definition in the non-target area to be lower than image definition in the target area, so as to achieve the purposes of reducing an amount of memory resources required for storing the first image and a bandwidth required for reading and writing the first image, thereby achieve the purposes of improving memory usage efficiency, saving storage space, accelerating image processing speed, reducing network transmission costs, adapting to different hardware configurations, and reducing manufacturing costs of terminal devices.

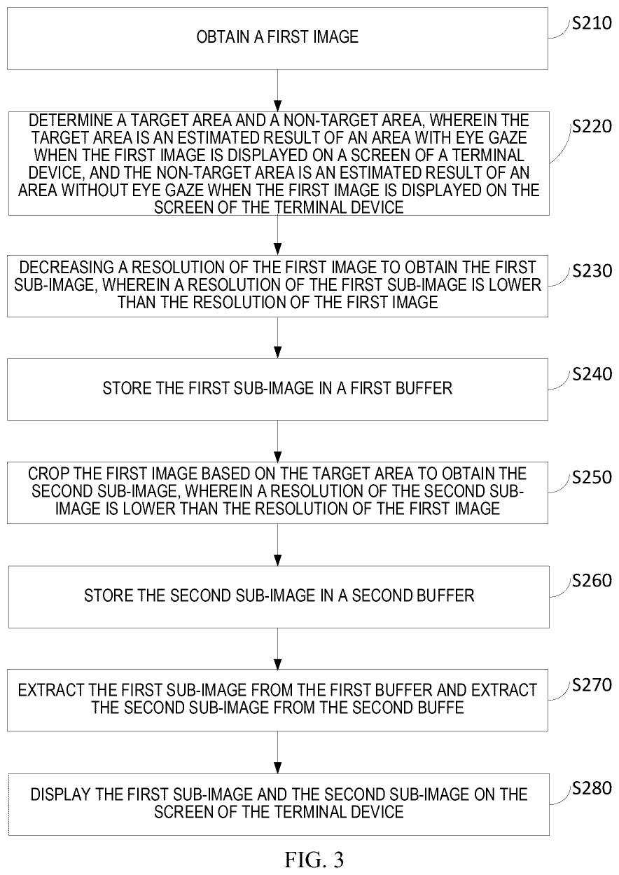

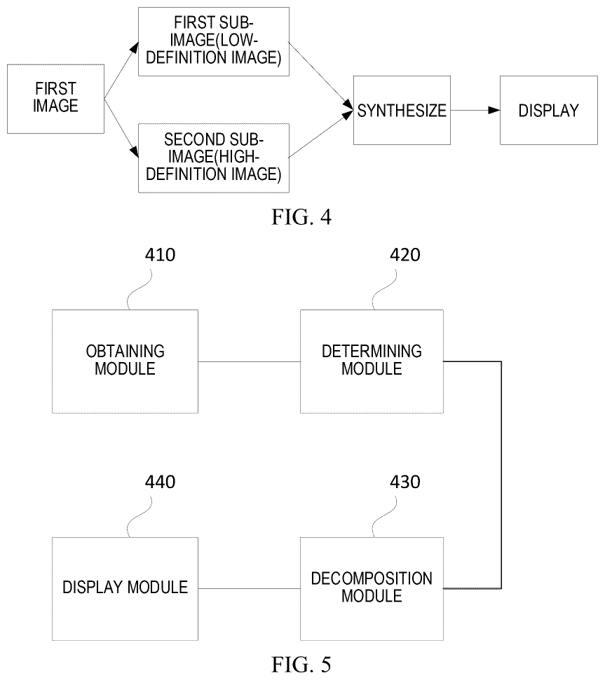

FIG. 3 is a flowchart of another method of image display according to an embodiment of the disclosure. FIG. 3 is a specific example of FIG. 2. FIG. 4 is a schematic diagram of an image display principle according to an embodiment of the disclosure. Referring to FIG. 3 and FIG. 4, the method of image display includes the following steps.

At S210, obtain a first image.

At S220, determine a target area and a non-target area, wherein the target area is an estimated result of an area with eye gaze when the first image is displayed on a screen of a terminal device, and the non-target area is an estimated result of an area without eye gaze when the first image is displayed on the screen of the terminal device.

At S230, decrease a resolution of the first image to obtain a first sub-image, wherein a resolution of the first sub-image is lower than the resolution of the first image.

The purpose of decreasing the resolution of the first image in this step is to compress the first image, to reduce image quality of the first image. The first sub-image is a result of compressing the first image. The first sub-image and the first image are images of different qualities, and the first sub-image and the first image include the same content (objects displayed in the images).

There is a plurality of implementation methods for this step, and this application is not limited thereto. In an example, if the resolution of the first image is (w, h), the resolution of the first sub-image is (w/m, h/m). m is a parameter determined based on a compression requirement for the first image. The resolution being (w, h) means that the first image includes w pixels in a horizontal direction and h pixels in a vertical direction. The resolution being (w/m, h/m) means that the first image includes w/m pixels in the horizontal direction and h/m pixels in the vertical direction. w, h, m, w/m, and h/m are positive integers, and m is greater than or equal to 2.

At S240, store the first sub-image in a first buffer.

At S250, crop the first image based on the target area to obtain a second sub-image, wherein a resolution of the second sub-image is lower than the resolution of the first image.

Optionally, an implementation method of this step includes: projecting the target area on the first image; and cropping a projection area corresponding to the target area in the first image, to obtain the second sub-image.

It should be emphasized that in this step, the second resolution is lower than the resolution of the first image because of cropping. Because the second sub-image is a part of the first image, a number of pixels included in the second sub-image is less than a number of pixels included in the first image, so that the resolution of second sub-image is lower than the resolution of the first image.

After this step is performed, definition of the second sub-image is the same as definition of the image in the target area in the first image. In other words, the second sub-image and the first image are images of the same quality, but the second sub-image includes less content (objects displayed in the images) than the first image.

In an example, the resolution of the first image is (w, h); the second resolution is (w/n, h/n); and n is a parameter determined based on a ratio of a size of the first image to a size of the target area. w, h, n, w/n, and h/n are positive integers, and n is greater than or equal to 2.

At S260, store the second sub-image in a second buffer.

Optionally, the first buffer and the second buffer are two different single buffers.

At S270, extract the first sub-image from the first buffer, and extract the second sub-image from the second buffer.

At S280, display the first sub-image and the second sub-image on the screen of the terminal device.

Optionally, an image layer of the second sub-image is located on an image layer of the first sub-image.

There is a plurality of implementation methods for this step. In an example, the first sub-image is stretched based on a target stretch coefficient; and the second sub-image and the stretched first sub-image are displayed on the screen of the terminal device. This arrangement makes it possible that the first sub-image can be displayed on the full screen in a low-definition manner during display.

Optionally, if the resolution of the first image is (w, h), the resolution of the first sub-image is (w/m, h/m), and the target stretch coefficient is m, the first sub-image can be displayed on the full screen in a low-definition manner.

Because the image layer of the second sub-image is located on the image layer of the first sub-image, the first sub-image blocks the target area (that is, with eye gaze) in the first sub-image. A result visually perceived by the user is that image definition in the non-target area (that is, an area with eye gaze) is lower than image definition in the target area (that is, an area without eye gaze) in the first image.

Optionally, in the foregoing technical solution, S210 to S270 are performed by the GPU, and S280 is performed by the HWC.

The foregoing technical solution provides a specific implementation method of image definition in the non-target area is lower than image definition in the target area in the first image when the first image is displayed on the screen of the terminal device.

It should be noted that if the prior art is used, the resolution of the first image stored in the buffer is (w, h) in order to make images at positions of the first image have high definition. That is, a size of the buffer required by the prior art is w*h. However, if the technical solution provided in this application is used, the resolution of the first sub-image stored in one buffer is (w/m, h/m), and the resolution of the second sub-image stored in the other buffer is (w/n, h/n). According to the technical solution provided in this application, a total size of the two buffers is

$$( \frac{1}{{m}^{2}} + \frac{1}{{n}^{2}} ) * w * h .$$

Obviously, compared with the prior art, the total size of the buffers required by the technical solution provided in this application is only

$$( \frac{1}{{m}^{2}} + \frac{1}{{n}^{2}} )$$

times of the size of the buffer required by the prior art.

Based on the foregoing technical solutions, optionally, the first sub-image and the second sub-image are synthesized to obtain a frame image to be displayed; and the frame image to be displayed is displayed on the screen of the terminal device. In some embodiments, this step may be performed by a DPU (Data Processing Unit) in the HWC. This arrangement does not require the video controller to be improved, and an existing video controller can smoothly convert the image to be displayed into electrical information for controlling a pixel unit in the screen to display an image.

After a user wears an extended reality device, an image seen by the user is a result magnified by a lens after the image is displayed by a display screen of the extended reality device. In this way, a field of view (FoV) is significantly improved, and a broader field of vision can be presented to the user. However, this method is accompanied by a problem of obvious pixelation of the image. A solution to this is to perform anti-aliasing on the frame image to be displayed.

In some scenarios, only one image can be anti-aliased in the HWC. In this regard, optionally, a graphics processor (that is, the GPU) performs anti-aliasing on the second sub-image; a hardware composer (that is, the HWC) performs anti-aliasing on the first sub-image; and the hardware composer (that is, the HWC) synthesizes the first sub-image and the second sub-image that are subjected to anti-aliasing to obtain the frame image to be displayed. In this way, an adverse phenomenon of obvious pixelation of the first image during display can be suppressed.

It may be understood that before the technical solutions disclosed in embodiments of the disclosure is used, the user shall be informed of types, usage scopes, usage scenarios, and the like of the personal information involved in the disclosure in an appropriate manner in accordance with relevant laws and regulations, and the authorization of the user shall be obtained.

For example, in response to receiving an active request from a user, prompt information is sent to the user to explicitly prompt the user that the operation requested by the user will require the personal information of the user to be acquired and used. Therefore, the user can independently choose whether to provide the personal information to software or hardware such as an electronic device, an application, a server, or a storage medium that performs operations of the technical solution of the disclosure, based on the prompt information.

As an optional but non-limiting implementation, for example, a manner of sending prompt information to the user in response to receiving the active request from the user may be a pop-up window, and the pop-up window may include the prompt information in text. In addition, the pop-up window may further carry a selection control for the user to select “agree” or “disagree” to provide the personal information to the electronic device.

In an example, the technical solution provided in the disclosure needs to determine the target area and the non-target area. In a process of determining the target area and the non-target area, using an image including the user, motion data of the user's head and/or eyes, and the like may be involved. Therefore, before the technical solution provided in the disclosure is used, the user needs to be informed and the authorization of the user needs to be obtained.

It may be understood that the foregoing process of notifying and obtaining the authorization of the user is merely illustrative and does not limit the implementation of the disclosure, and other methods that meet relevant laws and regulations may also be applied to the implementation of the disclosure.

It should be noted that, for the foregoing method embodiments, for ease of description, they are all described as a series of action combinations, but those skilled in the art should understand that the disclosure is not limited by the order of the described actions, because according to the disclosure, some steps may be performed in other orders or simultaneously. Secondly, those skilled in the art should also understand that the embodiments described in the specification are preferred embodiments, and the actions and modules involved are not necessarily required by the disclosure.

FIG. 5 is a schematic diagram of a structure of an apparatus for image display according to an embodiment of the disclosure. The apparatus for image display provided in the embodiment of the disclosure may be configured in a terminal device. Referring to FIG. 5, the apparatus for image display specifically includes: an obtaining module 410 configured to obtain a first image; a determining module 420 configured to determine a target area and a non-target area in the first image, wherein the target area is an estimated result of an area with eye gaze when the first image is displayed on a screen of a terminal device, and the non-target area is an estimated result of an area without eye gaze when the first image is displayed on the screen of the terminal device; a decomposition module 430 configured to obtain a first sub-image and a second sub-image based on the first image, wherein the first sub-image and the second sub-image are stored in different buffers, the first sub-image corresponds to both the target area and the non-target area, and the second sub-image corresponds to the target area; and a display module 440 configured to display the first sub-image and the second sub-image on the screen of the terminal device, to cause image definition in the non-target area to be lower than image definition in the target area in the first image.

Further, the apparatus further includes the decomposition module 430, configured to: decrease a resolution of the first image to obtain the first sub-image, wherein a resolution of the first sub-image is lower than the resolution of the first image; store the first sub-image in a first buffer; crop the first image based on the target area to obtain the second sub-image, wherein a resolution of the second sub-image is lower than the resolution of the first image; store the second sub-image in a second buffer; the display module configured to: before display the first sub-image and the second sub-image on the screen of the terminal device, extract the first sub-image from the first buffer and extract the second sub-image from the second buffer.

Further, the resolution of the first image is (w, h); the resolution of the first sub-image is (w/m, h/m), and the resolution of the second sub-image is (w/n, h/n); wherein m is a parameter determined based on a compression requirement for the first image, n is a parameter determined based on a ratio of a size of the first image to a size of the target area, w, h, m, n, w/m, h/m, w/n, and h/n are positive integers, and both m and n are greater than or equal to 2.

Further, the display module is configured to: stretch the first sub-image based on a target stretch coefficient; and display the second sub-image and the stretched first sub-image on the screen of the terminal device.

Further, the display module is configured to: synthesize the first sub-image and the second sub-image, to obtain a frame image to be displayed; and display the frame image to be displayed on the screen of the terminal device.

Further, the display module is configured to: perform anti-aliasing on the second sub-image by a graphics processor; perform anti-aliasing on the first sub-image by a hardware composer; and synthesize the first sub-image and the second sub-image that are subjected to anti-aliasing by the hardware composer, to obtain the frame image to be displayed.

Further, the obtaining module is configured to: obtain a plurality of image layers that constitute the first image; and synthesize the plurality of image layers to obtain the first image.

The image display apparatus provided in this embodiment of the disclosure may perform the steps in the image display method provided in the method embodiment of the disclosure, and has the same or corresponding beneficial effects, which are not described herein again.

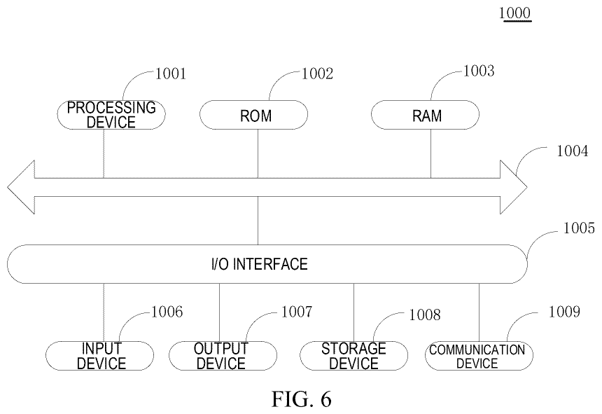

FIG. 6 is a schematic diagram of a structure of an electronic device according to an embodiment of the disclosure. Referring specifically to FIG. 6 below, FIG. 6 shows a schematic diagram of a structure suitable for implementing the electronic device 1000 in the embodiment of the disclosure. The electronic device 1000 in the embodiment of the disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the disclosure.

As shown in FIG. 6, the electronic device 1000 may include a processing device (such as a central processor and a graphics processor) 1001 that may perform a variety of appropriate actions and processing in accordance with a program stored in a read-only memory (ROM) 1002 or a program loaded from a storage device 1008 into a random-access memory (RAM) 1003, to implement the method of image display of the embodiment described in the disclosure. The RAM 1003 further stores various programs and information required for the operation of the electronic device 1000. The processing device 1001, the ROM 1002, and the RAM 1003 are connected to each other through a bus 1004. An input/output (I/O) interface 1005 is also connected to the bus 1004.

Generally, the following devices may be connected to the I/O interface 1005: an input device 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage device 1008 including, for example, a tape and a hard disk; and a communication device 1009. The communication device 1009 may allow the electronic device 1000 to perform wireless or wired communication with other devices to exchange information. Although FIG. 6 shows the electronic device 1000 having various devices, it should be understood that it is not required to implement or have all of the shown devices. It may be an alternative to implement or have more or fewer devices.

In particular, according to an embodiment of the disclosure, the process described above with reference to the flowcharts may be implemented as a computer software program. For example, the embodiment of the disclosure includes a computer program product, which includes a computer program carried on a non-transitory computer-readable medium, where the computer program includes program code for performing the method shown in the flowchart, to implement the method of image display as described above. In such an embodiment, the computer program may be downloaded from a network through the communication device 1009 and installed, installed from the storage device 1008, or installed from the ROM 1002. When the computer program is executed by the processing device 1001, the above-mentioned functions defined in the method of the embodiment of the disclosure are performed.

It should be noted that the above computer-readable medium described in the disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the disclosure, the computer-readable storage medium may be any tangible medium containing or storing a program that may be used by or in combination with an instruction execution system, apparatus, or device. In the disclosure, the computer-readable signal medium may include an information signal propagated in a baseband or as a part of a carrier, the information signal carrying computer-readable program code. The propagated information signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate by using any known or future-developed network protocol such as a hypertext transfer protocol (HTTP) and may be connected to digital information communication (for example, a communication network) in any form or medium. Examples of the communication network include a local area network (“LAN”), a wide area network (“WAN”), an international network (for example, the Internet), a peer-to-peer network (for example, an ad hoc peer-to-peer network), and any known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a first image; determine a target area and a non-target area, wherein the target area is an estimated result of an area with eye gaze when the first image is displayed on a screen of a terminal device, and the non-target area is an estimated result of an area without eye gaze when the first image is displayed on the screen of the terminal device; obtain a first sub-image and a second sub-image based on the first image, wherein the first sub-image and the second sub-image are stored in different buffers, the first sub-image corresponds to both the target area and the non-target area, and the second sub-image corresponds to the target area; and display the first sub-image and the second sub-image on the screen of the terminal device, to cause image definition in the non-target area to be lower than image definition in the target area.

Optionally, when the one or more programs are executed by the electronic device, the electronic device may further perform other steps described in the above embodiments.

The computer program code for performing the operations of the disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the descriptions in the embodiments of the disclosure may be implemented by means of software, or may be implemented by means of hardware. The name of a unit does not constitute a limitation on the unit itself in some cases.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the disclosure, the machine-readable medium may be a tangible medium, which may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the disclosure, the disclosure provides an electronic device, comprising: one or more processors; a memory configured to store one or more programs, wherein the one or more programs, when executed by the one or more processors, cause the one or more processors to perform the method of image display according to any of the disclosure.

According to one or more embodiments of the disclosure, the disclosure provides a computer-readable storage medium having a computer program stored thereon, wherein the program, when executed by a processor, perform the method of image display according to any of the disclosure.

This embodiment of the disclosure further provides a computer program product, where the computer program product includes a computer program or instructions, and when the computer program or instructions are executed by a processor, the image display method as described above is implemented.

It should be noted that in this specification, relationship terms such as “first” and “second” are merely used to distinguish one entity or operation from another entity or operation, and do not necessarily require or imply any actual relationship or order between these entities or operations. Moreover, the term “include”, “comprise”, or any other variant thereof is intended to cover non-exclusive inclusion, so that a process, method, article, or device that includes a series of elements not only includes those elements, but also includes other elements not explicitly listed, or further includes elements inherent to such a process, method, article, or device. Without more restrictions, an element defined by the statement “including a . . . ” does not exclude the presence of another identical element in the process, method, article, or device that includes the element.

The foregoing descriptions are merely specific implementations of the disclosure, so that persons skilled in the art can understand or implement the disclosure. Various modifications to these embodiments will be readily apparent to persons skilled in the art, and the general principles defined herein may be implemented in other embodiments without departing from the spirit or scope of the disclosure. Therefore, the disclosure will not be limited to the embodiments described herein, but is to comply with the widest scope consistent with the principles and novel features disclosed herein.

I/We claim:

1. A method of image display, comprising:
obtaining a first image;
determining a target area and a non-target area, wherein the target area is an estimated result of an area with eye gaze when the first image is displayed on a screen of a terminal device, and the non-target area is an estimated result of an area without eye gaze when the first image is displayed on the screen of the terminal device;
obtaining a first sub-image and a second sub-image based on the first image, wherein the first sub-image and the second sub-image are stored in different buffers, the first sub-image corresponds to both the target area and the non-target area, and the second sub-image corresponds to the target area; and
displaying the first sub-image and the second sub-image on the screen of the terminal device, to cause image definition in the non-target area to be lower than image definition in the target area.

2. The method of claim 1, wherein obtaining the first sub-image and the second sub-image based on the first image comprises:
decreasing a resolution of the first image to obtain the first sub-image, wherein a resolution of the first sub-image is lower than the resolution of the first image;
storing the first sub-image in a first buffer;
cropping the first image based on the target area to obtain the second sub-image, wherein a resolution of the second sub-image is lower than the resolution of the first image;
storing the second sub-image in a second buffer; and
wherein before displaying the first sub-image and the second sub-image on the screen of the terminal device, the method further comprises:
extracting the first sub-image from the first buffer and extracting the second sub-image from the second buffer.

3. The method of claim 2, wherein the resolution of the first image is (w, h), the resolution of the first sub-image is (w/m, h/m), and the resolution of the second sub-image is (w/n, h/n), wherein m is a parameter determined based on a compression requirement for the first image, n is a parameter determined based on a ratio of a size of the first image to a size of the target area, w, h, m, n, w/m, h/m, w/n, and h/n are positive integers, and both m and n are greater than or equal to 2.

4. The method of claim 3, wherein displaying the first sub-image and the second sub-image on the screen of the terminal device comprises:
stretching the first sub-image based on a target stretch coefficient; and
displaying the second sub-image and the stretched first sub-image on the screen of the terminal device.

5. The method of claim 1, wherein displaying the first sub-image and the second sub-image on the screen of the terminal device comprises:
synthesizing the first sub-image and the second sub-image, to obtain a frame image to be displayed; and
displaying the frame image on the screen of the terminal device.

6. The method of claim 5, wherein synthesizing the first sub-image and the second sub-image to obtain the frame image to be displayed further comprises:
performing anti-aliasing on the second sub-image by a graphics processor;
performing anti-aliasing on the first sub-image by a hardware composer; and
synthesizing the first sub-image and the second sub-image that are subjected to anti-aliasing by the hardware composer, to obtain the frame image to be displayed.

7. The method of claim 1, wherein obtaining the first image comprises:
obtaining a plurality of image layers that constitute the first image; and
synthesizing the plurality of image layers to obtain the first image.

8. The method of claim 1, wherein to cause the image definition in the non-target area to be lower than the image definition in the target area comprises:
reducing image definition of the first sub-image, and
keeping image definition of the second sub-image unchanged.

9. The method of claim 2, wherein cropping the first image based on the target area to obtain the second sub-image comprises:
projecting the target area on the first image; and
cropping a projection area corresponding to the target area in the first image, to obtain the second sub-image.

10. The method of claim 1, wherein an image layer of the second sub-image is located on an image layer of the first sub-image.

11. An electronic device, comprising:
one or more processors;
a storage device configured to store one or more programs,
wherein the one or more programs, when executed by the one or more processors, cause the one or more processors to perform acts comprising:
obtaining a first image;
determining a target area and a non-target area, wherein the target area is an estimated result of an area with eye gaze when the first image is displayed on a screen of a terminal device, and the non-target area is an estimated result of an area without eye gaze when the first image is displayed on the screen of the terminal device;
obtaining a first sub-image and a second sub-image based on the first image, wherein the first sub-image and the second sub-image are stored in different buffers, the first sub-image corresponds to both the target area and the non-target area, and the second sub-image corresponds to the target area; and
displaying the first sub-image and the second sub-image on the screen of the terminal device, to cause image definition in the non-target area to be lower than image definition in the target area.

12. The electronic device of claim 11, wherein obtaining the first sub-image and the second sub-image based on the first image comprises:
decreasing a resolution of the first image to obtain the first sub-image, wherein a resolution of the first sub-image is lower than the resolution of the first image;
storing the first sub-image in a first buffer;
cropping the first image based on the target area to obtain the second sub-image, wherein a resolution of the second sub-image is lower than the resolution of the first image;
storing the second sub-image in a second buffer; and
wherein before displaying the first sub-image and the second sub-image on the screen of the terminal device, the method further comprises:
extracting the first sub-image from the first buffer and extracting the second sub-image from the second buffer.

13. The electronic device of claim 12, wherein the resolution of the first image is (w, h), the resolution of the first sub-image is (w/m, h/m), and the resolution of the second sub-image is (w/n, h/n), wherein m is a parameter determined based on a compression requirement for the first image, n is a parameter determined based on a ratio of a size of the first image to a size of the target area, w, h, m, n, w/m, h/m, w/n, and h/n are positive integers, and both m and n are greater than or equal to 2.

14. The electronic device of claim 13, wherein displaying the first sub-image and the second sub-image on the screen of the terminal device comprises:
stretching the first sub-image based on a target stretch coefficient; and
displaying the second sub-image and the stretched first sub-image on the screen of the terminal device.

15. The electronic device of claim 11, wherein displaying the first sub-image and the second sub-image on the screen of the terminal device comprises:
synthesizing the first sub-image and the second sub-image, to obtain a frame image to be displayed; and
displaying the frame image on the screen of the terminal device.

16. The electronic device of claim 15, wherein synthesizing the first sub-image and the second sub-image to obtain the frame image to be displayed further comprises:
performing anti-aliasing on the second sub-image by a graphics processor;
performing anti-aliasing on the first sub-image by a hardware composer; and
synthesizing the first sub-image and the second sub-image that are subjected to anti-aliasing by the hardware composer, to obtain the frame image to be displayed.

17. The electronic device of claim 11, wherein obtaining the first image comprises:
obtaining a plurality of image layers that constitute the first image; and
synthesizing the plurality of image layers to obtain the first image.

18. The electronic device of claim 11, wherein to cause the image definition in the non-target area to be lower than the image definition in the target area comprises:
reducing image definition of the first sub-image, and
keeping image definition of the second sub-image unchanged.

19. The electronic device of claim 12, wherein cropping the first image based on the target area to obtain the second sub-image comprises:
projecting the target area on the first image; and
cropping a projection area corresponding to the target area in the first image, to obtain the second sub-image.

20. A non-transitory computer-readable storage medium having a computer program stored thereon, wherein the program, when executed by a processor, perform acts comprising:
obtaining a first image;
determining a target area and a non-target area, wherein the target area is an estimated result of an area with eye gaze when the first image is displayed on a screen of a terminal device, and the non-target area is an estimated result of an area without eye gaze when the first image is displayed on the screen of the terminal device;
obtaining a first sub-image and a second sub-image based on the first image, wherein the first sub-image and the second sub-image are stored in different buffers, the first sub-image corresponds to both the target area and the non-target area, and the second sub-image corresponds to the target area; and
displaying the first sub-image and the second sub-image on the screen of the terminal device, to cause image definition in the non-target area to be lower than image definition in the target area.
